(19) United States
(12) Patent Application Publication
(10) Pub. No.: US 2020/0403489 A1
(43) Pub. Date: Dec. 24, 2020

(54) ROTOR ASSEMBLY AND MOTOR COMPRISING THE SAME

(71) Applicant: Zhongshan Broad-Ocean Motor Co., Ltd., Zhongshan (CN)

(72) Inventors: Chongsheng ZENG, Zhongshan (CN); Mingpan PAN, Zhongshan (CN); Jianwei JIN, Zhongshan (CN)

(21) Appl. No.: 16/697,108

(22) Filed: Nov. 26, 2019

(30) Foreign Application Priority Data
Jun. 24, 2019 (CN) 201920949309.3

(51) Int. Cl. H02K 41/035; H02K 21/22; H02K 9/06

(52) U.S. Cl. CPC H02K 41/035; H02K 9/06; H02K 21/22

(57) ABSTRACT

A rotor assembly including a rotor core, a plurality of permanent magnets, and a plastic body. The rotor core includes an inner core and a plurality of outer cores surrounding the inner core. The inner core includes an axial through hole. The plurality of outer cores is circumferentially disposed at intervals around the inner core; a radial groove is formed between every two adjacent outer cores. The plurality of permanent magnets is embedded in a plurality of radial grooves, respectively. The plurality of radial grooves each includes a first opening away from the inner core and a second opening towards the inner core; every outer core includes a first end away from the inner core and a second end towards the inner core. The first end includes two first hooks disposed on two sides of the first end, respectively.

### CROSS-REFERENCE TO RELATED APPLICATIONS

Pursuant to 35 U.S.C. § 119 and the Paris Convention Treaty, this application claims foreign priority to Chinese Patent Application No. 201920949309.3 filed Jun. 24, 2019, the contents of which, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to a rotor assembly and a motor comprising the same.

Conventionally, a permanent magnet rotor includes a permanent magnet 1a and a rotor core 2a. The rotor core 2a includes an annular ring 22a provided with a central hole 21a and a plurality of magnetic conductive blocks 23a projecting from the outer side of the annular ring 22a, and a radial groove 24a is formed between the adjacent two magnetic conductive blocks 23a. The permanent magnet 1a is embedded in the radial groove 24a, and the annular ring 22a includes a plurality of bulges protruding toward the permanent magnet 1a, and the bulges abut against the inner side surface of the permanent magnet 1a. The contact area of the annular ring 22a and the plurality of magnetic conductive blocks 23a is narrow.

### SUMMARY

Provided is a rotor assembly comprising a rotor core; a plurality of permanent magnets; and a plastic body.

The rotor core comprises an inner core and a plurality of outer cores surrounding the inner core; the inner core comprises an axial through hole; the plurality of outer cores is circumferentially disposed at intervals around the inner core; a radial groove is formed between every two adjacent outer cores; and the plurality of permanent magnets is embedded in a plurality of radial grooves, respectively; the plurality of radial grooves each comprises a first opening away from the inner core and a second opening towards the inner core; every outer core comprises a first end away from the inner core and a second end towards the inner core; the first end comprises two first hooks disposed on two sides of the first end, respectively; the first opening of every radial groove is located between a first hook of an outer core and a first hook of a next outer core; the second end comprises a bulge; the bulge protrudes towards the second opening to form two second hooks; and the plurality of permanent magnets each is clamped between the two first hooks and the two second hooks; the inner core comprises an outer surface; the outer surface protrudes towards the second opening to form a plurality of spaced teeth; the plurality of teeth each is staggered with or opposite to the second opening; and the plastic body is disposed in gaps between the inner core and the plurality of outer cores.

Each of the plurality of teeth is opposite to a middle part of the second opening.

The plurality of teeth is less than or equal to the plurality of permanent magnets in number.

The plastic body comprises an upper end plate, a lower end plate, a plurality of peripheral connection ribs, and an inner ring; the upper end plate and the lower end plate are disposed on two ends of the rotor core, respectively; two ends of each of the plurality of peripheral connection ribs are connected to the upper end plate and the lower end plate, respectively; each of the plurality of peripheral connection ribs is disposed in the first opening; the inner ring is connected to the upper end plate and the lower end plate and fills the gaps between the inner core and the plurality of outer cores.

The plurality of outer cores each comprises a through hole; the plastic body comprises a plurality of inner connection ribs; the plurality of inner connection ribs each is connected to the upper end plate and the lower end plate and fills the through hole.

The distance L1 between the bulge and the teeth is greater than or equal to 1.5 mm.

The distance L2 between the teeth and an inner surface of the plurality of permanent magnets is greater than or equal to 1.5 mm.

The distance L3 between the outer surface of the inner core and the bulge is greater than or equal to 2 mm.

The plurality of outer cores each comprises a first location hole; the upper end plate comprises a plurality of second location holes; the lower end plate comprises a plurality of third location holes; and the first location hole, the plurality of second location holes, and the plurality of third location holes are aligned with each other.

The disclosure also provides a motor comprising a stator assembly, a rotation shaft, and the aforesaid rotor assembly, and the rotation shaft is disposed in the axial through hole of the inner core.

The rotor assembly comprises a plastic body to fill the gaps between the inner core and the plurality of outer cores. This improves the damping effect and structural strength of the rotor assembly.

### BRIEF DESCRIPTION OF THE DRAWINGS

FIG. 1 is a schematic diagram of a rotor assembly in the related art;

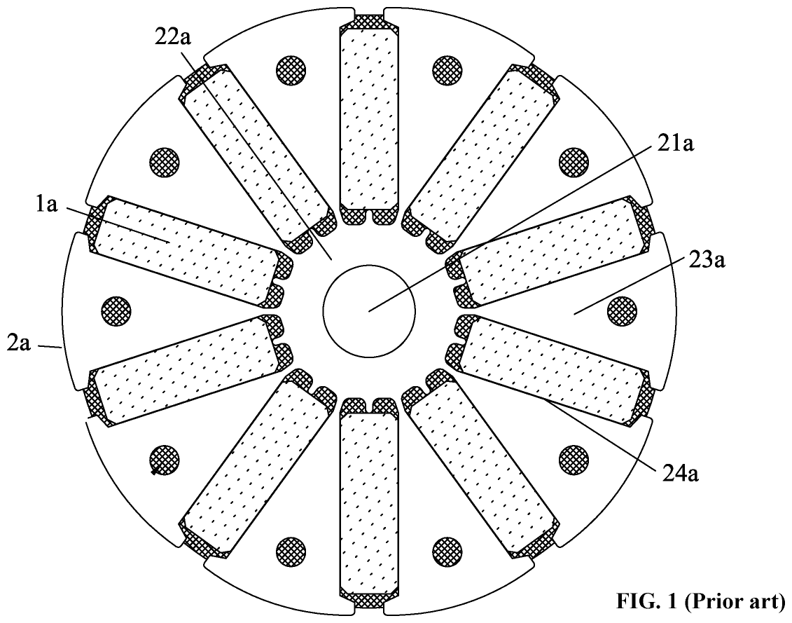

FIG. 2 is a schematic diagram of a rotor assembly according to one embodiment of the disclosure;

FIG. 3 is an enlarged view of part C in FIG. 2;

FIG. 4 is a stereogram of a rotor assembly comprising an embedded plastic body according to one embodiment of the disclosure;

FIG. 5 is a side view of a rotor assembly according to one embodiment of the disclosure;

FIG. 6 is a sectional view taken from line A-A in FIG. 5;

FIG. 7 is a sectional view taken from line B-B in FIG. 5;

FIG. 8 is a schematic diagram of a rotor assembly according to another embodiment of the disclosure; and

FIG. 9 is a schematic diagram of a rotor assembly according to still another embodiment of the disclosure.

### DETAILED DESCRIPTIONS

To further illustrate, embodiments detailing a rotor assembly and a motor comprising the same are described below. It should be noted that the following embodiments are intended to describe and not to limit the disclosure.

### Example 1

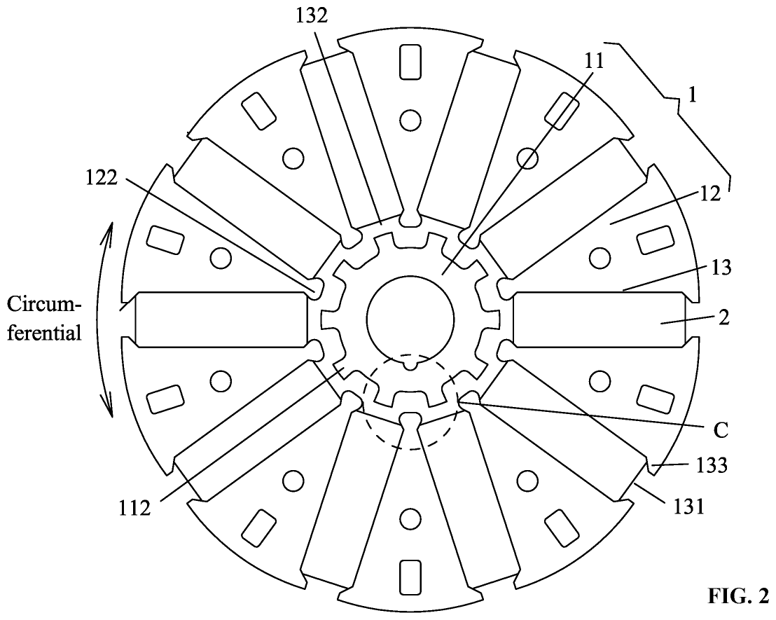

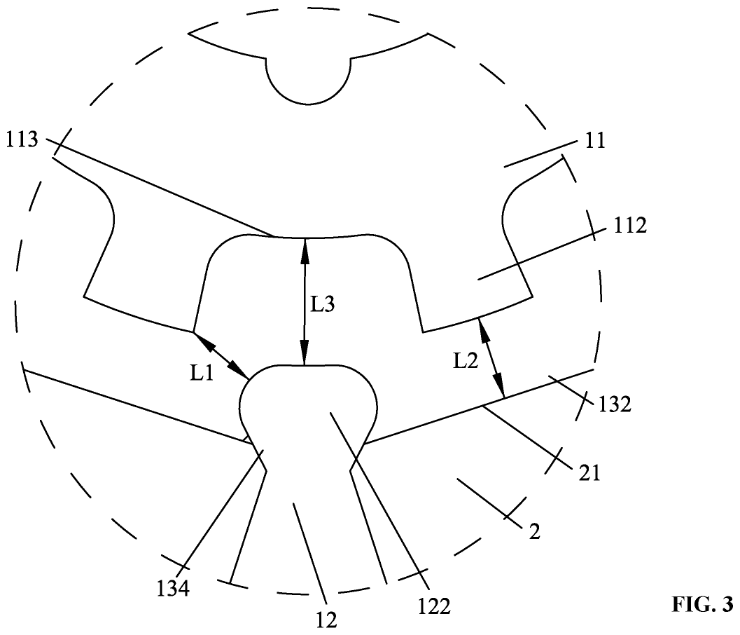

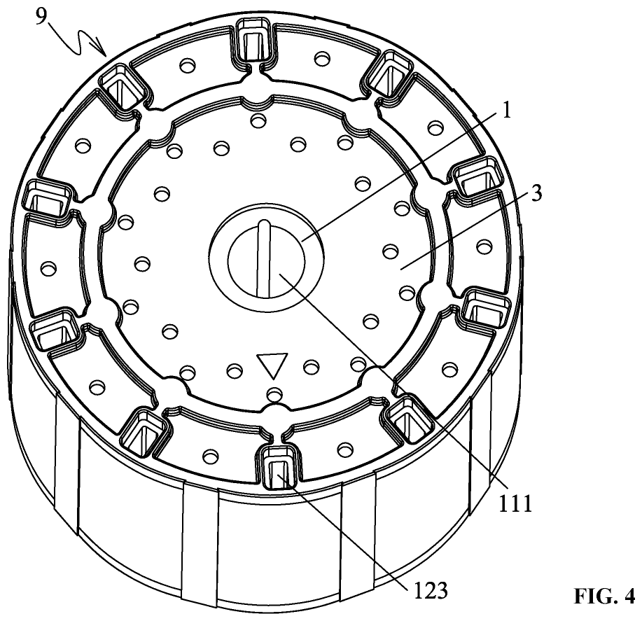

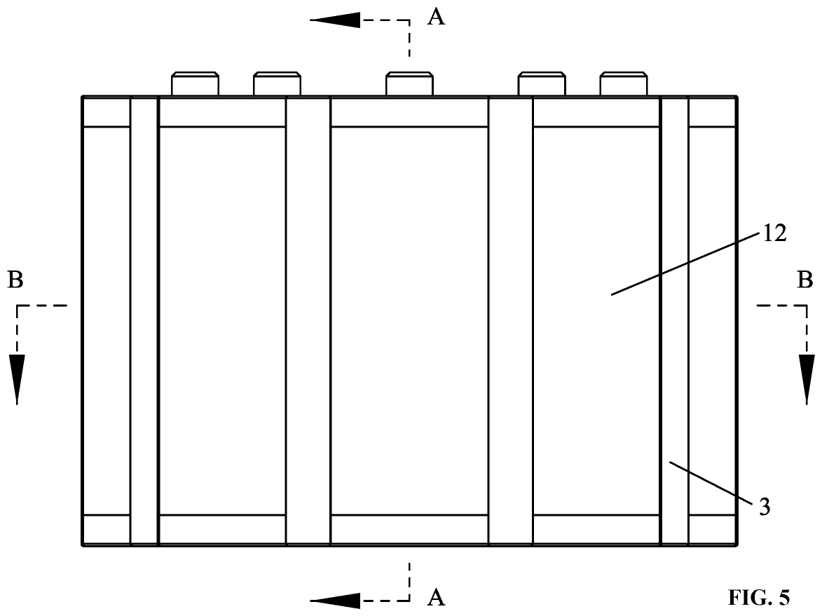

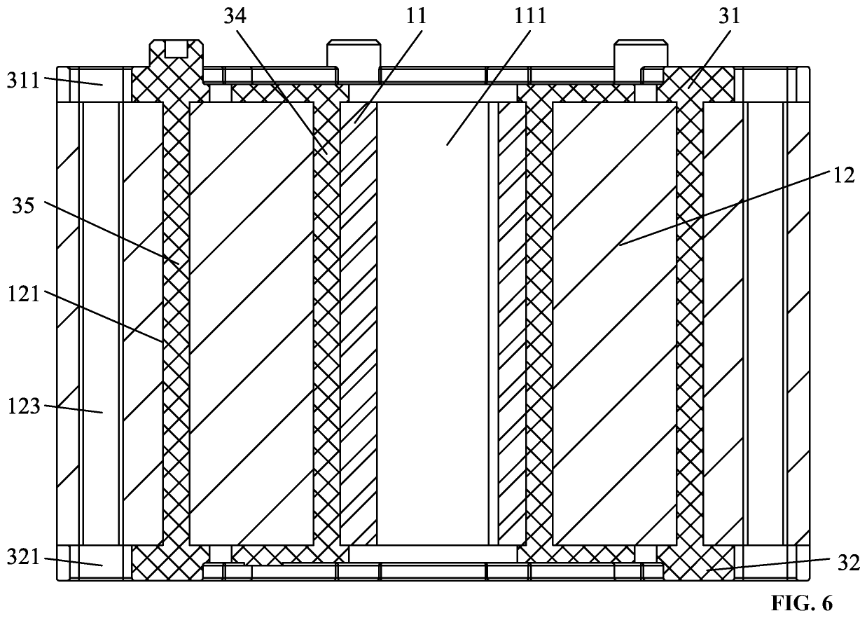

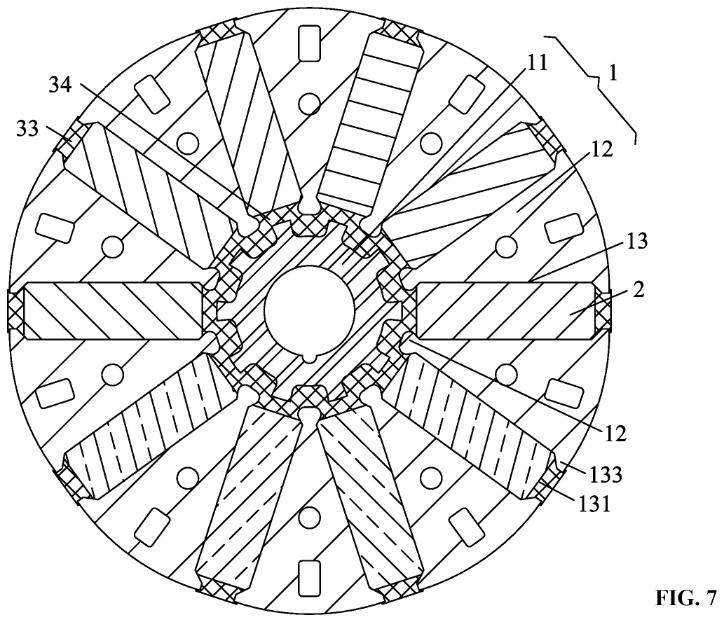

As shown in FIG. 2-7, the rotor assembly provided by the Example 1 comprises a rotor core 1, a plurality of permanent magnets 2, and a plastic body 3; the plurality of permanent magnets 2 are embedded in the rotor core 1; the rotor core 1 and the permanent magnets are injection molded by the plastic body 3 for production of rotor assembly in one-piece. The rotor assembly 1 comprises an inner core 11 and a plurality of outer cores 12; the inner core 11 comprises an axial through hole 111; the plurality of outer cores 12 is circumferentially disposed at intervals around the inner core 11; a radial groove 13 is formed between every two adjacent outer cores 12; and the plurality of permanent magnets 2 is embedded in a plurality of radial grooves 13, respectively; the first opening 131 of every radial groove 13 is located between a first hook 133 of an outer core and a first hook 133 of a next outer core; the outer core 12 comprises a bulge 122; the bulge 122 protrudes towards the second opening to form two second hooks 134; the plurality of permanent magnets 2 each is clamped between the two first hooks 133 and the two second hooks 134; the inner core 11 comprises an outer surface 113; the outer surface 113 protrudes towards the second opening to form a plurality of spaced teeth 112; the plurality of spaced teeth 112 each is staggered with or opposite to the second opening 132; the plastic body 3 is disposed in gaps between the inner core 11 and the plurality of outer cores 12. Under the premise of cost reduction and shock absorption, the rotor assembly also ensures the performance thereof and the uniformity of the plastic body between the inner core 11 and the outer core 12, thus improving the structural strength.

The plurality of spaced teeth 112 each is corresponding to the second opening 132, and each of the plurality of spaced teeth 112 are opposite to a middle part of the second opening 132. When the teeth 112 are disposed corresponding to the second opening 132, the thickness of the gaps between the inner core 11 and the plurality of outer cores 12 are uniform, and the structural strength of the plastic body 3 is also ensured.

The number of the teeth 112 is equal to the number of the permanent magnets 2, so that there is a maximum distance between the inner core 11 and the outer core 12, further improving the structural strength.

The plastic body 3 comprises an upper end plate 31, a lower end plate 32, a plurality of peripheral connection ribs 33, and an inner ring 34; the upper end plate 31 and the lower end plate 32 are disposed on two ends of the rotor core 1, respectively; two ends of each of the plurality of peripheral connection ribs 33 are connected to the upper end plate 31 and the lower end plate 32, respectively; each of the plurality of peripheral connection ribs 33 is disposed in the first opening 131; the inner ring 34 is connected to the upper end plate 31 and the lower end plate 32 and fills the gaps between the inner core 11 and the plurality of outer cores 12. The molded body 3 is easy for installation and injection molding in one piece.

The plurality of outer cores 12 each comprises a through hole 121; the plastic body 3 comprises a plurality of inner connection ribs 35; the plurality of inner connection ribs 35 each is connected to the upper end plate 31 and the lower end plate 32 and fills the through hole 121. The inner connecting ribs 35 reinforces the connection between the upper end plate 31 and the lower end plate 32, reinforcing the overall strength of the plastic body 3.

A distance L1 between the bulge 122 and the teeth 112 is greater than or equal to 1.5 mm; a distance L2 between the teeth 122 and an inner surface 21 of the plurality of permanent magnets 2 is greater than or equal to 1.5 mm; a distance L3 between the outer surface 113 of the inner core 11 and the bulge 122 is greater than or equal to 2 mm. These reasonable parameters ensure the structural strength while effectively preventing magnetic leakage and maintaining the performance of the rotor assembly.

The plurality of outer cores each comprises a first location hole 123; the upper end plate 31 comprises a plurality of second location holes 311; the lower end plate 32 comprises a plurality of third location holes 321; and the first location hole 123, the plurality of second location holes 311, and the plurality of third location holes 321 are configured to align with the outer cores 12 and the permanent magnets 2 during injection molding.

### Example 2

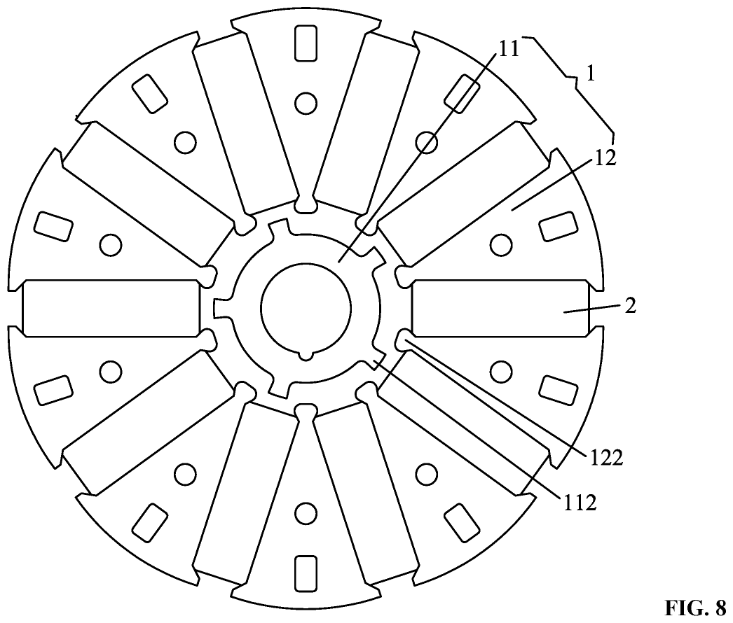

As shown in FIG. 8, the rotor assembly in Example 2 is similar to that in Example 1 but differs as follows:

In Example 2, the number of the teeth 112 is smaller than the number of the permanent magnets 2, and the ratio of the number of the teeth 112 to the number of the permanent magnets 2 is 1:2.

### Example 3

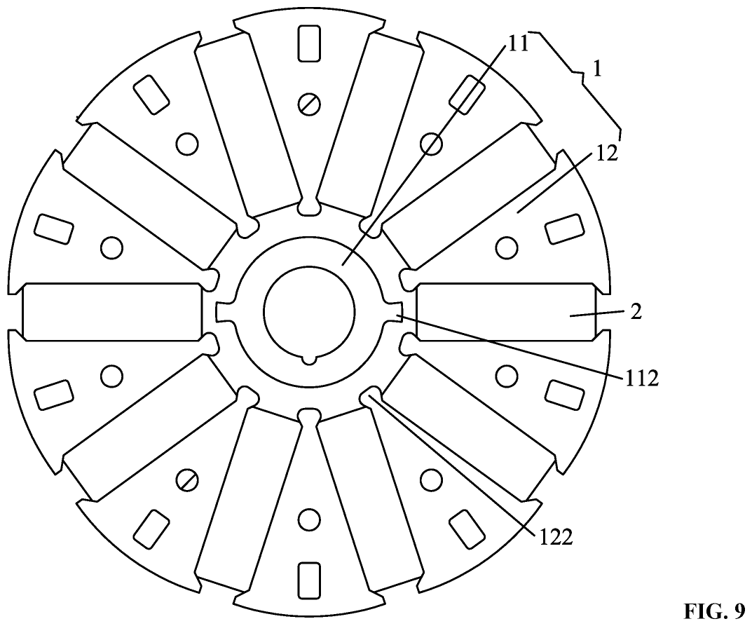

As shown in FIG. 9, the rotor assembly in Example 3 is similar to that in Example 1 but differs as follows:

In Example 3, the number of the teeth 112 is smaller than the number of the permanent magnets 2, and the number of the teeth 2 is two.

The ratio of the number of the teeth 112 to the number of the permanent magnets 2 is not limited to the above three examples, but will not be described here.

### Example 4

The example provides a motor comprising a stator assembly, a rotating shaft and a rotor assembly 9. The rotor assembly 9 is as described in Example 1, Example 2 or Example 3; the rotating shaft is disposed in the axial through hole 111 of the inner core 11. The rotor assembly is a modified product, can improve the performance of the motor and reduce the production cost of the motor.

It will be obvious to those skilled in the art that changes and modifications may be made, and therefore, the aim in the appended claims is to cover all such changes and modifications.

What is claimed is:

1. A rotor assembly, comprising:
1) a rotor core;
2) a plurality of permanent magnets;
3) a plastic body;
wherein:
the rotor core comprises an inner core and a plurality of outer cores surrounding the inner core;
the inner core comprises an axial through hole;
the plurality of outer cores is circumferentially disposed at intervals around the inner core;
a radial groove is formed between every two adjacent outer cores; and the plurality of permanent magnets is embedded in a plurality of radial grooves, respectively;
the plurality of radial grooves each comprises a first opening away from the inner core and a second opening towards the inner core;
every outer core comprises a first end away from the inner core and a second end towards the inner core;
the first end comprises two first hooks disposed on two sides of the first end, respectively;
the first opening of every radial groove is located between a first hook of an outer core and a first hook of a next outer core;
the second end comprises a bulge; the bulge protrudes towards the second opening to form two second hooks; and the plurality of permanent magnets each is clamped between the two first hooks and the two second hooks;
the inner core comprises an outer surface; the outer surface protrudes towards the second opening to form a plurality of spaced teeth; the plurality of spaced teeth each is staggered with or is opposite to the second opening; and
the plastic body is disposed in gaps between the inner core and the plurality of outer cores.

2. The assembly of claim 1, wherein each of the plurality of spaced teeth is opposite to a middle part of the second opening.

3. The assembly of claim 2, wherein the plurality of spaced teeth is less than or equal to the plurality of permanent magnets in number.

4. The assembly of claim 3, wherein the plastic body comprises an upper end plate, a lower end plate, a plurality of peripheral connection ribs, and an inner ring; the upper end plate and the lower end plate are disposed on two ends of the rotor core, respectively; two ends of each of the plurality of peripheral connection ribs are connected to the upper end plate and the lower end plate, respectively; each of the plurality of peripheral connection ribs is disposed in the first opening; the inner ring is connected to the upper end plate and the lower end plate and fills the gaps between the inner core and the plurality of outer cores.

5. The assembly of claim 4, wherein the plurality of outer cores each comprises a through hole; the plastic body comprises a plurality of inner connection ribs; the plurality of inner connection ribs each is connected to the upper end plate and the lower end plate and fills the through hole.

6. The assembly of claim 2, wherein a distance L1 between the bulge and the teeth is greater than or equal to 1.5 mm.

7. The assembly of claim 3, wherein a distance L1 between the bulge and the teeth is greater than or equal to 1.5 mm.

8. The assembly of claim 4, wherein a distance L1 between the bulge and the teeth is greater than or equal to 1.5 mm.

9. The assembly of claim 5, wherein a distance L1 between the bulge and the teeth is greater than or equal to 1.5 mm.

10. The assembly of claim 6, wherein a distance L2 between the teeth and an inner surface of the plurality of permanent magnets is greater than or equal to 1.5 mm.

11. The assembly of claim 7, wherein a distance L2 between the teeth and an inner surface of the plurality of permanent magnets is greater than or equal to 1.5 mm.

12. The assembly of claim 8, wherein a distance L2 between the teeth and an inner surface of the plurality of permanent magnets is greater than or equal to 1.5 mm.

13. The assembly of claim 9, wherein a distance L2 between the teeth and an inner surface of the plurality of permanent magnets is greater than or equal to 1.5 mm.

14. The assembly of claim 10, wherein a distance L3 between the outer surface of the inner core and the bulge is greater than or equal to 2 mm.

15. The assembly of claim 11, wherein a distance L3 between the outer surface of the inner core and the bulge is greater than or equal to 2 mm.

16. The assembly of claim 12, wherein a distance L3 between the outer surface of the inner core and the bulge is greater than or equal to 2 mm.

17. The assembly of claim 13, wherein a distance L3 between the outer surface of the inner core and the bulge is greater than or equal to 2 mm.

18. The assembly of claim 14, wherein the plurality of outer cores each comprises a first location hole; the upper end plate comprises a plurality of second location holes; the lower end plate comprises a plurality of third location holes; and the first location hole, the plurality of second location holes, and the plurality of third location holes are aligned with each other.

19. The assembly of claim 17, wherein the plurality of outer cores each comprises a first location hole; the upper end plate comprises a plurality of second location holes; the lower end plate comprises a plurality of third location holes; and the first location hole, the plurality of second location holes, and the plurality of third location holes are aligned with each other.

20. A motor, comprising a stator assembly, a rotation shaft, and a rotor assembly of claim 1, wherein the rotation shaft is disposed in the axial through hole of the inner core of the rotor core.
